(19) United States
(12) Patent Application Publication
(10) Pub. No.: US 2026/0086209 A1
(43) Pub. Date: Mar. 26, 2026

(54) TWO-DIMENSIONAL SCANNING GALVANOMETER DEVICE

(71) Applicant: SUTENG INNOVATION TECHNOLOGY CO., LTD., Shenzhen (CN)

(72) Inventor: Fenglian XU, Shenzhen (CN)

(73) Assignee: SUTENG INNOVATION TECHNOLOGY CO., LTD., Shenzhen (CN)

(21) Appl. No.: 19/336,494

(22) Filed: Sep. 22, 2025

(30) Foreign Application Priority Data
Sep. 26, 2024 (CN) 202411357073.6

(51) Int. Cl. G01S 7/481; G01S 17/02; G02B 26/08; G02B 26/10

(52) U.S. Cl. CPC G01S 7/4817; G01S 17/02; G02B 26/085; G02B 26/10

(57) ABSTRACT

A two-dimensional scanning galvanometer device includes a first magnet, a second magnet, a magnetic yoke, a galvanometer chip, a base, a cover plate, and a flexible circuit board. The first magnet is a ring-shaped permanent magnet and is disposed above the magnetic yoke; the second magnet is a permanent magnet and is disposed above the magnetic yoke; the magnetic yoke is configured to support the first magnet and the second magnet; the galvanometer chip is disposed above the first magnet; the first magnet, the second magnet, the magnetic yoke, and the galvanometer chip are all located inside the base; the cover plate is connected to the base and is disposed above the base; and the flexible circuit board is connected to the galvanometer chip.

### CROSS-REFERENCE TO RELATED APPLICATION

The present application claims the benefit of priority to Chinese Patent Application No. 202411357073.6 filed on Sep. 26, 2024, which is hereby incorporated by reference in its entirety.

### TECHNICAL FIELD

The present application relates to the field of LiDAR detection technology, and in particular to a two-dimensional scanning galvanometer device and a LiDAR.

### BACKGROUND

The Micro-Electro-Mechanical System (MEMS) two-dimensional scanning galvanometer is an important optical scanning device with the advantages of fast response speed, high scanning accuracy, mass production, and low cost. It is widely applied in the field of LiDAR.

There are currently two common structures for MEMS two-dimensional scanning galvanometers: moving coils and moving permanent magnets. In related technologies, to enhance the electromagnetic force driving the movement of the galvanometer, the number of permanent magnets or magnetic conductive sheets is usually increased, resulting in a complex structure of the two-dimensional scanning galvanometer device, high assembly difficulty, large overall size, and increased material and processing costs.

### SUMMARY

In order to solve or partially solve the problems existing in the related technology, an embodiment of the present application provides a two-dimensional galvanometer scanning device, which generates a strong magnetic field through two permanent magnets. The magnetic field system of the present application has a simple structure and is easy to assemble, thereby reducing the overall size of the two-dimensional galvanometer scanning device and lowering material and processing costs.

The embodiments of the present application provide a two-dimensional galvanometer scanning device, including a first magnet, a second magnet, a magnetic yoke, a galvanometer chip, a base, a cover plate, and a flexible circuit board.

The first magnet is a ring-shaped permanent magnet, positioned above the magnetic yoke. The second magnet is a permanent magnet, positioned above the magnetic yoke. The magnetic yoke is configured to support the first magnet and the second magnet. The galvanometer chip is positioned above the first magnet. The first magnet, the second magnet, the magnetic yoke, and the galvanometer chip are all located within the base. The cover plate is connected to the base and positioned above the base. The flexible circuit board is connected to the galvanometer chip. The magnetic field system is simple in structure. The magnetic field system can generate a strong magnetic field using only two permanent magnets, without the need for additional permanent magnets or magnetic conductive sheets, reducing material and processing costs, while also reducing the overall size and weight of the two-dimensional scanning galvanometer device.

In some embodiments, the outer and inner contours of the first magnet are both rounded rectangles, and its surface is configured to position and support the galvanometer chip. The first magnet is processed in an integrated manner, thereby reducing errors introduced by multiple processing and assembly, and making its surface have a high degree of flatness. The surface of the first magnet is configured to position the galvanometer chip, which improves the assembly accuracy of the galvanometer chip and reduces the offset of the optical device, thereby improving the quality and performance of the two-dimensional scanning galvanometer device.

In some embodiments, the second magnet is disposed in the rounded rectangular through hole of the first magnet, where the first magnet and the second magnet generate a magnetic field that causes the galvanometer chip to move.

In some embodiments, the material of the magnetic yoke is a high permeability material, and the magnetic yoke is bonded and fixed to the first magnet and the second magnet through the adhesive in the groove. The magnetic yoke is configured to guide and concentrate the magnetic field generated by the first magnet and the second magnet, reducing magnetic field loss. During the production process, the first magnet and the second magnet can be quickly and accurately positioned on the magnetic yoke through the groove. The permanent magnets can be effectively fixed in a short time through the adhesive, which is easy to use and can be mass-produced. In addition, the adhesive has excellent durability and corrosion resistance, is capable of withstanding various environmental conditions, protects the magnetic yoke and the permanent magnet from the influence of environmental factors, and ensures the stability and reliability of the device.

In some embodiments, the base is a housing, and the cavity inside the housing is configured to support the magnetic yoke and the first magnet, where the first magnet, the second magnet, the magnetic yoke, and the galvanometer chip are all located in the cavity of the base.

In some embodiments, the galvanometer chip includes a movable coil frame, a base, a reflector, a first torsion axis, and a second torsion axis. The outer contour of the movable coil frame is connected to the base through the second torsion axis, and the inner contour of the movable coil frame is connected to the reflector through the first torsion axis. The first torsion axis is located on both sides of the reflector in the vertical direction, and the second torsion axis is located on both sides of the movable coil frame in the horizontal direction. When the movable coil frame moves around the first torsion axis and the second torsion axis simultaneously, it can drive the reflector to move around the first torsion axis and the second torsion axis, thereby achieving two-dimensional field of view scanning.

In some embodiments, the movable coil frame has multiple turns of metal conductive coils and is disposed above the rounded rectangular through hole area in the middle of the first magnet.

In some embodiments, the cover plate is positioned above the galvanometer chip and is connected and fixed to the base. The cover plate also includes a viewing window, and the side wall of the viewing window is inclined. The cover plate is connected and fixed to the base to protect the components inside the base, thereby extending the service life of the two-dimensional scanning galvanometer device.

In some embodiments, one end of the flexible circuit board is connected to the galvanometer chip, and the other end is connected to an external power source for energizing the conductive coil in the movable coil frame.

In some embodiments, the first magnet and the second magnet are magnetized in a multi-pole manner. The magnetization direction of the first magnet and the second magnet is the thickness direction of the permanent magnet, and the magnetic domain direction of the permanent magnet is parallel to the magnetization direction. The first magnet and the second magnet are both magnetized in a multi-pole manner, which ensures the uniformity and stability of magnetization and also improves production efficiency. In the process of magnetizing the permanent magnet, the magnetic domain direction of the permanent magnet is parallel to the magnetization direction, which can avoid performance degradation caused by the inconsistency between the magnetic domain direction and the magnetization direction.

The present application discloses a two-dimensional scanning galvanometer device. The magnetic field system of the device is simple in structure. It only requires a first magnet, a second magnet, and a magnetic yoke to provide strong magnetic field strength. There is no need to add additional permanent magnets, which reduces material costs and reduces the overall size and weight of the two-dimensional scanning galvanometer device. Among them, the ring-shaped first magnet is processed in an integrated manner, and its surface flatness is high. It can serve as the positioning surface of the galvanometer chip and support the galvanometer chip, thereby improving the assembly accuracy of the galvanometer chip and reducing the offset of the optical device. In addition, since the magnetic field generated by the middle second magnet is utilized, the required magnetic induction intensity can be achieved without the need for additional magnetic conductive sheets, and the processing cost is also reduced.

### BRIEF DESCRIPTION OF DRAWINGS

FIG. 1 is a schematic diagram of the structure of a two-dimensional scanning galvanometer device according to some embodiments of the present application;

FIG. 2 is a schematic diagram of a magnetic field lines cloud diagram generated by a magnetic field system of a two-dimensional scanning galvanometer device according to some embodiments of the present application;

FIG. 3 is a schematic diagram of the exploded structure of a two-dimensional scanning galvanometer device according to some embodiments of the present application;

FIG. 4 is a schematic diagram of the structure of a galvanometer chip in a two-dimensional scanning galvanometer device according to some embodiments of the present application;

FIG. 5 is a front view and a cross-sectional view of a two-dimensional scanning galvanometer device according to some embodiments of the present application;

FIG. 6 is a schematic diagram of the structure of a cover plate in a two-dimensional scanning galvanometer device according to some embodiments of the present application;

FIG. 7 is a schematic diagram of the position of a two-dimensional scanning galvanometer device inside a solid-state LiDAR according to some embodiments of the present application;

FIG. 8 is a schematic diagram of the structure of a window on a cover plate of a two-dimensional scanning galvanometer device according to some embodiments of the present application;

FIG. 9 is a schematic diagram of a magnetization method for a first magnet and a second magnet according to some embodiments of the present application; and

FIG. 10 is a schematic diagram of a magnetic field lines cloud diagram generated by a magnetic field system of a two-dimensional scanning galvanometer device according to some embodiments of the present application.

### DETAILED DESCRIPTION

In order to explain the purpose, technical solutions, and advantages of the present application clearer, the following description is provided in further detail below with reference to the accompanying drawings and embodiments. It should be understood that the embodiments described herein are only some embodiments of the present application, rather than all embodiments. Based on the embodiments of the present application, all other embodiments obtained by ordinary technicians in this field without creative efforts are within the scope of protection of the present application.

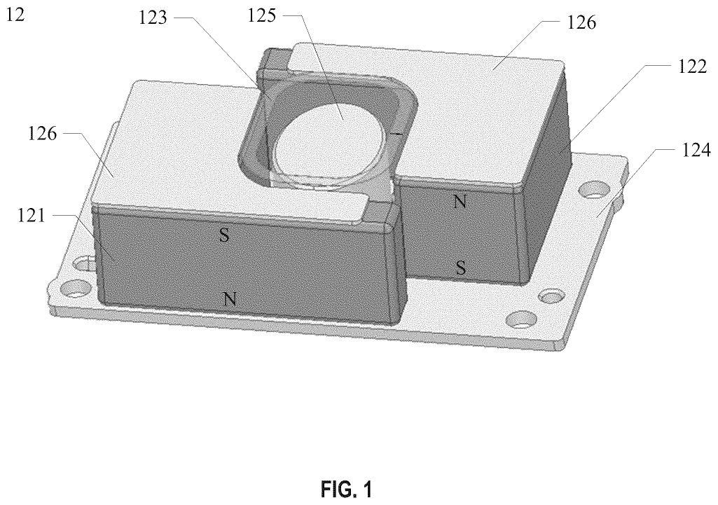

As shown in FIG. 1, in one embodiment, a two-dimensional scanning galvanometer device 12 adopting a moving coil structure includes a permanent magnet 121, a permanent magnet 122, a movable conductive coil frame 123, a magnetic yoke 124, a middle magnetic conductive part 125, and a magnetic conductive sheet 126. The permanent magnet 121, the permanent magnet 122, the magnetic yoke 124, and the middle magnetic conductive part 125 constitute the magnetic field system of the two-dimensional scanning galvanometer device 12.

In one embodiment, permanent magnet 121 and permanent magnet 122 are both L-shaped permanent magnets. Both L-shaped permanent magnets are disposed on the surface of magnetic yoke 124 and supported by magnetic yoke 124. In the vertical direction, the upper surface of permanent magnet 121 is an S pole and the lower surface is an N pole; the upper surface of permanent magnet 122 is an N pole and the lower surface is an S pole. Furthermore, permanent magnet 121 and permanent magnet 122 are located below movable conductive coil frame 123, providing a magnetic field that causes movable conductive coil frame 123 to move. Movable conductive coil frame 123 is disposed on a two-dimensional scanning galvanometer chip. In one embodiment, when the two L-shaped permanent magnets are assembled, their upper surfaces serve as the positioning surface for the two-dimensional scanning galvanometer chip. Due to the height difference between the upper surfaces of the two L-shaped permanent magnets, the two-dimensional scanning galvanometer chip is subjected to additional stress and mirror offset, thereby affecting the operating performance of the LiDAR.

In one embodiment, the material of the magnetic yoke 124 is a high permeability material, and the magnetic yoke 124 is configured to guide and concentrate the magnetic field generated by the permanent magnet 121 and the permanent magnet 122, thereby reducing magnetic field losses. The middle magnetic conductive part 125 is located below the movable conductive coil frame 123 and between the permanent magnet 121 and the permanent magnet 122, and is fixed to the upper surface of the magnetic yoke 124. When viewed from above, the movable conductive coil frame 123 has an inner contour and an outer contour, and the middle magnetic conductive part 125 is completely within the inner contour of the movable conductive coil frame 123. In one embodiment, the material of the magnetic yoke 124 is a high permeability material, and its shape is elliptical, and is configured to provide a low magnetic resistance path for the magnetic field. Therefore, the magnetic field passing through the movable conductive coil frame 123 tends to enter and leave the middle magnetic conductive part 125 at an angle closer to 90 degrees. That is, under the action of the middle magnetic conductive part 125, the magnetic field around the movable conductive coil frame 123 is enhanced, thereby providing a greater driving torque for the movable conductive coil frame 123.

In one embodiment, in order to maintain the required magnetic induction intensity, it is usually necessary to add a magnetic conductive sheet 126 to the upper surface of the L-shaped permanent magnet. The material of the magnetic conductive sheet 126 is also a high magnetic permeability material, which provides a low magnetic resistance path for the magnetic field, guides and focuses the magnetic field around the movable conductive coil frame 123, so as to achieve the required magnetic field intensity. Due to the high processing precision requirements of the magnetic conductive sheet 126, the shape of the middle magnetic conductive part 125 is slightly complicated, resulting in high manufacturing costs. In addition, the magnetic field system in the two-dimensional scanning galvanometer device 12 in the above embodiments is complex. In addition to the two L-shaped permanent magnets, the middle magnetic conductive part 125 and the magnetic conductive sheet 126 are also required to maintain the required magnetic induction intensity, resulting in a high overall material cost. The complex magnetic field system in the above comparative embodiments also causes the overall structure of the two-dimensional scanning galvanometer device 12 to be complex, difficult to assemble, and large in overall size and weight.

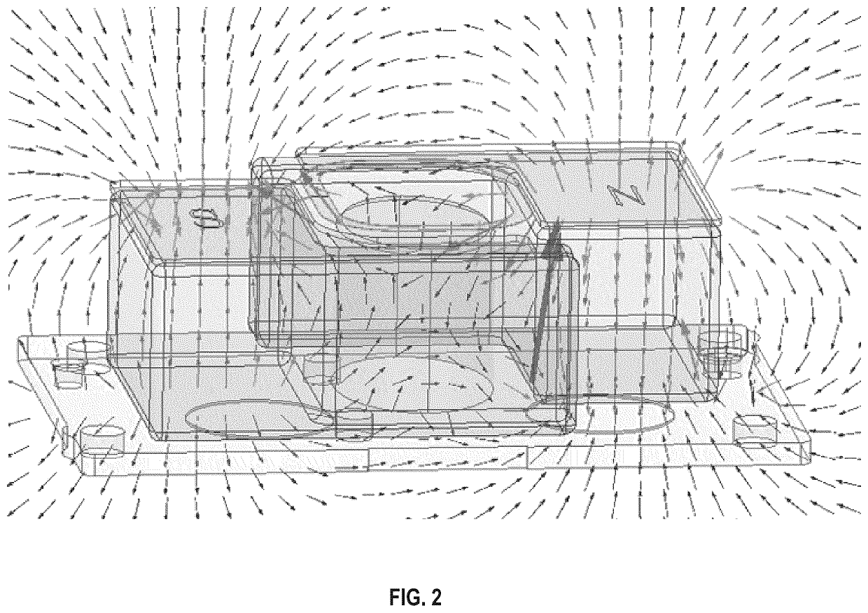

In one embodiment, a magnetic field lines cloud diagram generated by the magnetic field system shown in FIG. 1 is shown in FIG. 2. The magnetic field lines generated by the magnetic field system composed of the permanent magnet 121, the permanent magnet 122, the magnetic yoke 124, and the middle magnetic conductive part 125 are relatively evenly distributed. Under the action of the middle magnetic conductive part 125, more magnetic field lines are gathered around the movable coil frame 123, increasing the magnetic induction intensity around the movable coil frame 123, thereby generating a larger driving torque. The magnetic yoke 124 is located below the two L-shaped permanent magnets, guiding and gathering the magnetic field lines of the two L-shaped permanent magnets, helping to “close” the path of the magnetic field lines and reduce magnetic field losses.

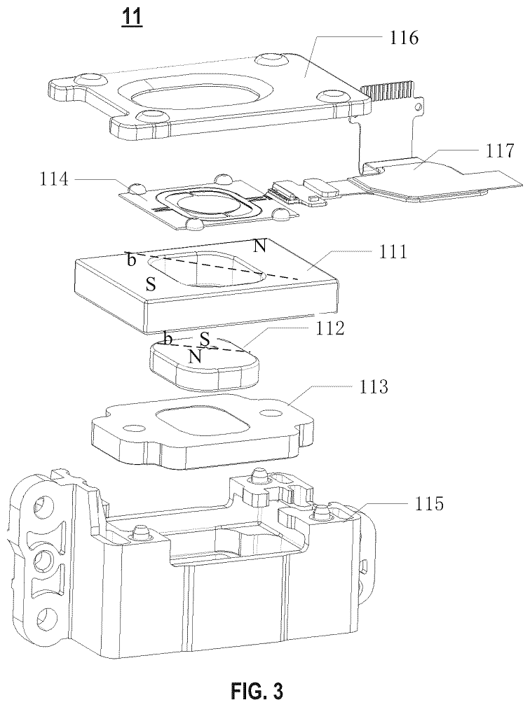

As shown in FIG. 3, an embodiment of the present application provides a two-dimensional scanning galvanometer device 11, including a first magnet 111, a second magnet 112, a magnetic yoke 113, a galvanometer chip 114, a base 115, a cover plate 116, and a flexible circuit board 117. The first magnet 111, the second magnet 112, the magnetic yoke 113, and the galvanometer chip 114 are all disposed inside the base 115, and the cover plate 116 is disposed above the base 115. The flexible circuit board 117 is connected to the galvanometer chip 114 and disposed outside the base 115.

The first magnet 111, the second magnet 112, and the magnetic yoke 113 together form a magnetic field system that moves the galvanometer chip 114. The galvanometer chip 114 is disposed above the magnetic field system. The galvanometer chip 114 is disposed on the upper surface of the first magnet 111 to achieve two-dimensional scanning for the LiDAR.

In an embodiment, the first magnet 111 is a ring-shaped permanent magnet with a rounded rectangular outer and inner contours, and is disposed above the magnetic yoke 113. The through hole located at the geometric center of the first magnet 111 is a rounded rectangular hole, which is configured to accommodate the second magnet 112 and provide space for the movement of the galvanometer chip 114.

The second magnet 112 is a permanent magnet, which is disposed above the magnetic yoke 113 and is located in a rounded rectangular through hole at the geometric center of the ring-shaped first magnet 111. In some embodiments, the shape of the second magnet 112 can be a rectangular parallelepiped, a cube, a cylinder, or other structures. In some embodiments, the material of the first magnet 111 is a permanent magnetic material, and the material of the second magnet 112 can be a permanent magnetic material or a high magnetic permeability material. In embodiments of the present application, the materials of the first magnet 111 and the second magnet 112 are both permanent magnetic materials to increase the magnetic field intensity and improve the driving torque.

The material of the magnetic yoke 113 is a high permeability material and is configured to guide and concentrate the magnetic field generated by the first magnet 111 and the second magnet 112 to the desired location, thereby reducing magnetic path loss and enhancing magnetic field intensity. In some embodiments, the material of the magnetic yoke 113 may include various high permeability materials, such as silicon steel sheets and ferrite. The shape of the magnetic yoke 113 can be a rectangular parallelepiped, a cube, a cylinder, or other structures.

In an embodiment of the present application, a two-dimensional scanning galvanometer device 11 is provided. The magnetic field system is simple in structure. The first magnet 111, the second magnet 112, and the magnetic yoke 113 can provide strong magnetic induction intensity, making assembly easy, reducing the overall size of the two-dimensional galvanometer scanning device, and lowering material costs. In addition, the first magnet 111 and the second magnet 112 are both simple in shape and easy to process. They can be integrally formed, reducing processing costs.

In an embodiment, the ring-shaped first magnet 111 is processed in an integrated manner, resulting in a highly flat surface. Furthermore, the upper surface of the first magnet 111 can serve as a positioning surface for the galvanometer chip 114, and serving as an assembly reference for the galvanometer chip 114. This can improve the assembly accuracy of the galvanometer chip 114 and reduce the offset of the optical components in the galvanometer chip 114.

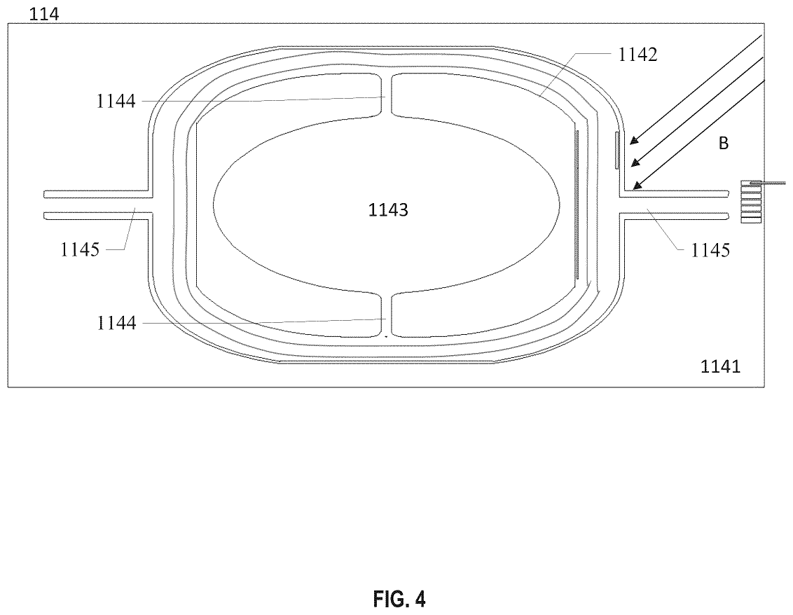

As shown in FIG. 4, the galvanometer chip 114 includes a base 1141, a movable coil frame 1142, a reflector 1143, a first torsion axis 1144, and a second torsion axis 1145. The base 1141 is connected to the movable coil frame 1142 through the second torsion axis 1145, and the movable coil frame 1142 is connected to the reflector 1143 through the first torsion axis 1144. In the vertical direction, the first torsion axis 1144 is disposed on both sides of the reflector 1143; in the horizontal direction, the second torsion axis 1145 is disposed on both sides of the outer contour of the movable coil frame 1142. In some embodiments, the first torsion axis 1144 is perpendicular to the second torsion axis 1145.

The movable coil frame 1142 has multiple turns of metal conductive coils and is disposed above the ring-shaped first magnet 111. The movable coil frame 1142 is disposed directly above the rounded rectangular through hole area in the middle of the ring-shaped first magnet 111, that is, the projection of the movable coil frame 1142 on the surface of the first magnet 111 is completely within the rounded rectangular through hole. When viewed from above, the outer contour of the movable coil frame 1142 is within the contour of the rounded rectangular through hole in the middle of the ring-shaped first magnet 111. The second magnet 112 is disposed directly below the movable coil frame 1142, that is, the projection of the second magnet 112 on the surface of the galvanometer chip 114 is completely within the outer contour of the movable coil frame 1142.

In some embodiments, the flexible circuit board 117 is disposed on one side of the galvanometer chip 114, with one end thereof connected to the galvanometer chip 114 through a wire. The other end of the flexible circuit board 117 is connected to an external power source, thereby energizing the conductive coil in the movable coil frame 1142.

When the conductive coil in the movable coil frame 1142 is energized and current flows through the coil, it is subjected to the Ampere force in the magnetic field B, generating a torque that deflects the movable coil frame 1142. Because the inner contour of the movable coil frame 1142 is connected to the first torsion axis 1144 and the outer contour is connected to the second torsion axis 1145, under the action of the Ampere force, the movable coil frame 1142 can simultaneously undergo torsional movement about the first torsion axis 1144 and the second torsion axis 1145. In some embodiments, since the reflector 1143 is connected to the movable coil frame 1142 through the first torsion axis 1144, the reflector 1143 is affected by the movement of the movable coil frame 1142 and will vibrate simultaneously about the first torsion axis 1144 and the second torsion axis 1145, thereby achieving two-dimensional scanning of a field of view.

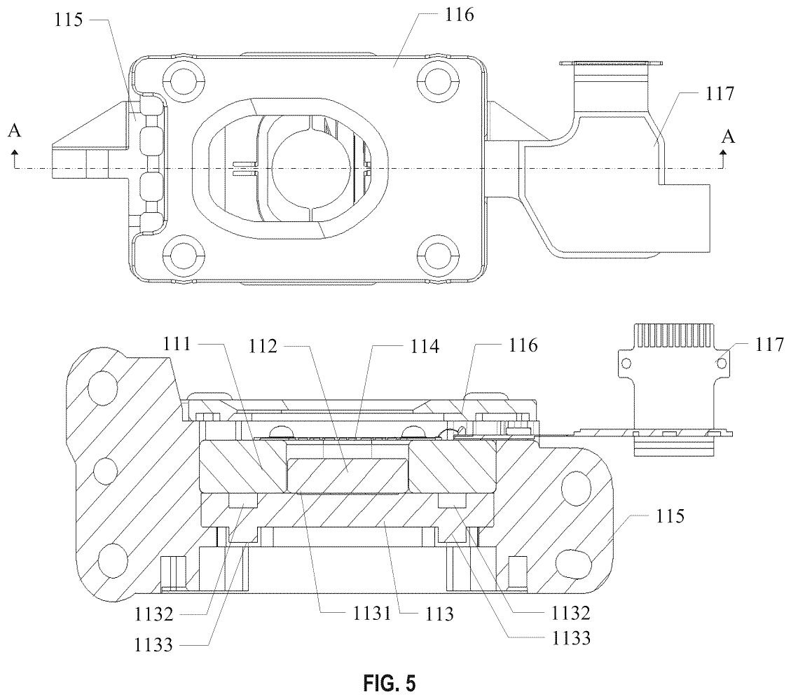

As shown in FIG. 5, the cover plate 116 is connected to the base 115 to protect the first magnet 111, the second magnet 112, the magnetic yoke 113 and the galvanometer chip 114 inside, thereby reducing the probability of damage thereof, so that the two-dimensional scanning galvanometer device 11 can have a longer service life, thereby allowing the LiDAR to have a longer service life.

The base 115 includes a first magnet 111, a second magnet 112, a magnetic yoke 113, and a galvanometer chip 114. The magnetic yoke 113 is disposed below the first magnet 111 and the second magnet 112 to support the first magnet 111 and the second magnet 112. The first magnet 111 is disposed below the galvanometer chip 114 to support and secure the galvanometer chip 114.

The second magnet 112 is fixed to the upper surface of the magnetic yoke 113 through the adhesive in the groove 1131 in the middle of the magnetic yoke 113. The second magnet 112 completely covers the groove 1131 in the middle of the magnetic yoke 113. When viewed from above, the outline of the groove in the middle of the magnetic yoke 113 is completely within the outline of the second magnet 112. After the second magnet 112 is adhesively bonded to the upper surface of the magnetic yoke 113, the first magnet 111 is fixed to the upper surface of the magnetic yoke 113 through the adhesive in the cylindrical grooves 1132 on the left and right sides of the magnetic yoke 113. The upper surface of the second magnet 112 is lower than the upper surface of the first magnet 111 in the vertical direction, thereby providing space for the movable coil frame 1142 and the reflector 1143 in the galvanometer chip 114 to move.

Furthermore, after the magnetic yoke 113, the second magnet 112, and the first magnet 111 are bonded and fixed to form an insert, the insert is placed in an injection mold for injection molding, thereby forming a base 115 as a whole. The manufactured base 115 is a housing, and the cavity inside it is configured to support the magnetic yoke 113 and the first magnet 111. In some embodiments, there are two raised positioning posts 1133 on the left and right sides of the bottom of the magnetic yoke 113, which are configured to position the insert during the injection molding process. This injection molding process in the embodiments described above is also called embedded molding, which facilitates the installation and fixation of the first magnet 111, the second magnet 112 and the magnetic yoke 113, and simplifies the assembly steps of the two-dimensional scanning galvanometer device 11. Producing the base 115 through the embedded molding process can not only effectively fix the insert inside it, but also reduce the overall size and weight of the two-dimensional scanning galvanometer device, thereby improving its reliability and durability. In addition, the insert process can realize automated production, which not only ensures the consistency and accuracy of the products, but also improves production efficiency and reduces production costs.

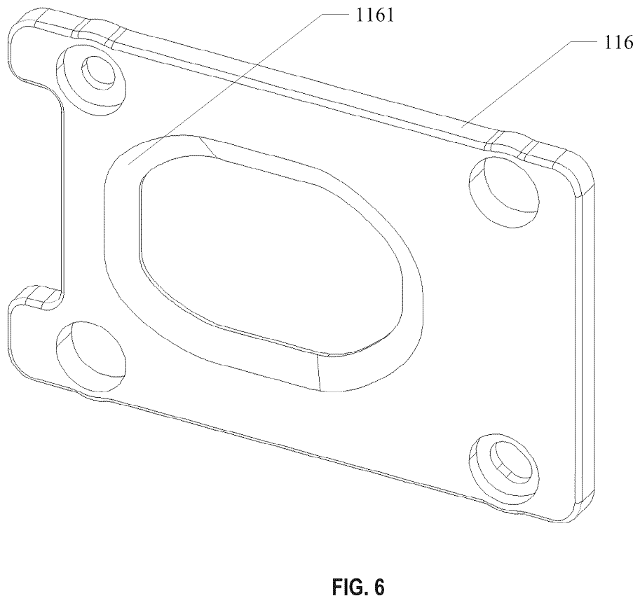

As shown in FIG. 6, the cover plate 116 according to embodiments described above further includes a window 1161 for laser beams to enter or exit the two-dimensional scanning galvanometer device 11. In some embodiments, the window 1161 is located to the left of the center of the cover plate 116, and the side wall of the window 1161 is inclined to maximize the field of view covered by the detection laser beams after being reflected by the galvanometer chip 114.

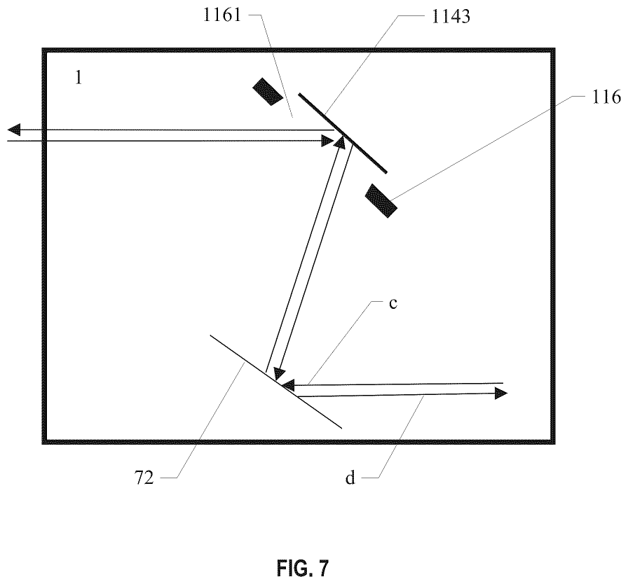

In an embodiment, as shown in FIG. 7, the internal device in the solid-state LiDAR 1 generates a detection laser beam c, which is first received by the optical deflection device 72 and reflected to the reflector 1143 in the galvanometer chip 114. The reflector 1143 reflects the detection laser beam c and then emits it outward, thereby scanning the detection field of view. The echo laser beam d returned after being reflected by the object is first received by the reflector 1143 and deflected to the optical deflection device 72, and then deflected by the optical deflection device 72 and received by the internal device in the solid-state LiDAR 1.

The reflector 1143 in the galvanometer chip 114 achieves two-dimensional deflection by moving about a first torsion axis 1144 and a second torsion axis 1145. The detection laser beam c is first emitted toward the optical deflection device 72, deflected by the optical deflection device 72, and then emitted toward the reflector 1143. The reflector 1143 reflects the detection laser beam c and then emits it outward, covering the vertical and horizontal field of view angle ranges, thereby scanning the two-dimensional field of view. The reflector 1143 vibrates about the first torsion axis 1144 so that the detection laser beam c covers the horizontal field of view angle range, and vibrates about the second torsion axis 1145 so that the detection laser beam c covers the vertical field of view angle range. The optical path of the echo laser beam d is coaxial with the optical path of the detection laser beam c, but in opposite directions.

Both the detection laser beam c and the echo laser beam d must pass through the window 1161 on the cover plate 116, so that the detection laser beam c generated in the solid-state LiDAR 1 is emitted onto the object being measured, and finally the laser beam reflected back from the object is received by the device in the solid-state LiDAR 1. In some embodiments, the two-dimensional scanning galvanometer device 11 in the solid-state LiDAR 1 is not placed along the vertical direction, but is instead positioned at a certain angle to the vertical direction. When the position of the optical deflection device 72 in the solid-state LiDAR 1 is fixed, the window 1161 is located to the left of the center of the cover plate 116 to ensure that the reflector 1143 on the galvanometer chip 114 can receive and reflect the maximum number of laser beams, thereby expanding the two-dimensional field of view of the scan.

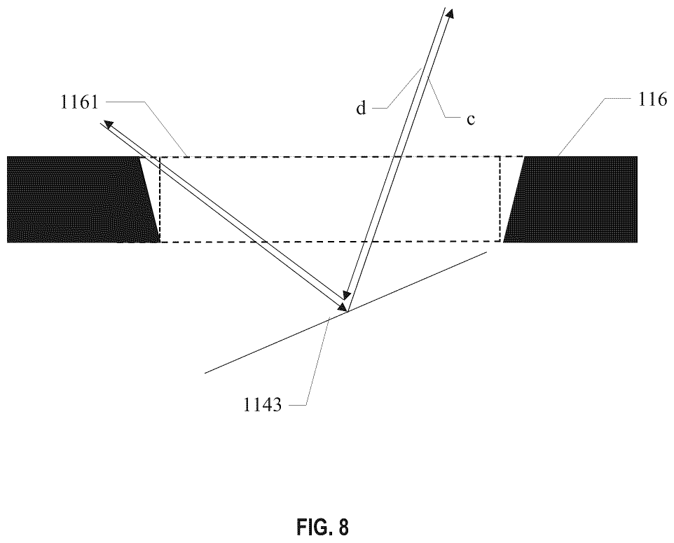

In an embodiment, as shown in FIG. 8, the side wall of the window 1161 is an inclined surface. Compared with a vertical side wall, the inclined side wall can increase the transmission of the number of the laser beams passing through the window 1161. Specifically, as the slope of the inclined surface decreases, the number of laser beams passing through will increase accordingly, which helps to expand the scanning range of the two-dimensional field of view. In an embodiment of the present application, the position of the window 1161 is determined according to the installation position of the two-dimensional scanning galvanometer device 11 inside the solid-state LiDAR 1 and the relative position of the galvanometer chip 114. In order to ensure the maximum field of view scanning range of the two-dimensional scanning galvanometer device 11, the position of the window 1161 on the cover plate 116 should be adjusted accordingly based on the relative position of the two-dimensional scanning galvanometer device 11 in the solid-state LiDAR 1.

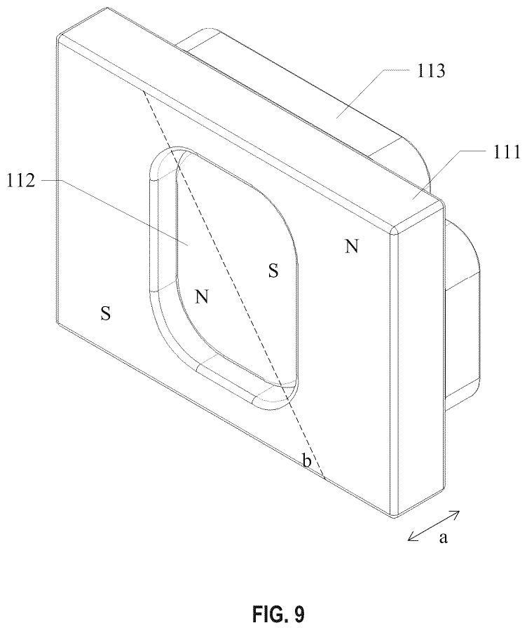

In an embodiment, as shown in FIG. 9, the magnetization direction of the first magnet 111 and the second magnet 112 is the thickness direction of the permanent magnet. In an embodiment of the present application, the surface of the first magnet 111 that cooperates with the magnetic yoke 113 is defined as the lower surface of the first magnet 111, and the surface that cooperates with the galvanometer chip 114 is defined as the upper surface of the first magnet 111. The magnetic poles of the upper surface and the lower surface of the first magnet 111 and the second magnet 112 are opposite in polarity. In the process of magnetizing the permanent magnet, the magnetic domain direction of the permanent magnet is parallel to the magnetization direction to avoid performance degradation caused by the inconsistency between the magnetic domain direction and the magnetization direction.

In an embodiment, the first magnet 111 and the second magnet 112 are both magnetized using a multi-pole method. Multi-pole magnetization is performed using a customized magnetization fixture, and after magnetization, multiple north poles and south poles can be formed on a plane. In an embodiment of the present application, the first magnet 111 and the second magnet 112 are both magnetized diagonally and subjected to multi-pole magnetization. The first magnet 111 and the second magnet 112 simultaneously present north poles and south poles on the same plane, and the magnetic pole boundary line b is shown in FIG. 9.

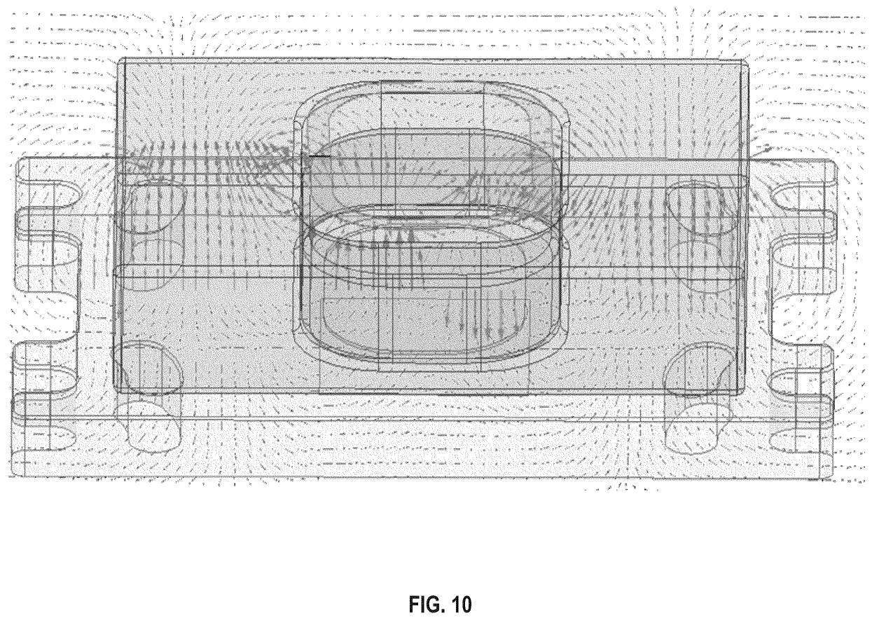

In an embodiment of the present application, a magnetic field lines cloud diagram generated by the magnetic field system in the two-dimensional scanning galvanometer device 11 is shown in FIG. 10. The magnetic field system composed of the first magnet 111, the second magnet 112 and the magnetic yoke 113 generates relatively dense magnetic field lines, especially around the movable coil frame 1142, where the density of the magnetic field lines is more significant. This shows that the magnetic field system in the present application can provide a strong magnetic field intensity around the movable coil frame 1142, thereby generating a large driving torque. In other embodiments, in order to further increase the magnetic field intensity around the movable coil frame 1142 and improve the scanning performance of the two-dimensional field of view, a magnetic conductive sheet can be added to the surface of the first magnet 111.

As shown in FIG. 2 and FIG. 10, compared with the magnetic field system in the comparative embodiment, the magnetic field system in the embodiment of the present application can better apply and focus the magnetic field on the movable coil frame 1142. When the current in the coils in the movable coil frame 1142 remains unchanged, the magnetic field system in the embodiment of the present application can enhance the magnetic field intensity along the two torsion axis directions on the movable coil frame 1142, thereby generating a larger driving torque.

The magnetic field system in the embodiment of the present application can effectively reduce the overall size of the two-dimensional scanning galvanometer device 11. Because the magnetic field generated by the second magnet 112 is utilized, the size of the permanent magnet required to generate the same magnetic field intensity at the movable coil frame 1142 is reduced, especially the thickness. Therefore, the overall size of the two-dimensional scanning galvanometer device 11 can be reduced.

The above contents are only exemplary embodiments of the present application, but the protection scope of the present application is not limited thereto. Any technician familiar with the technical field can easily think of changes or substitutions within the technical scope disclosed in the present application, which shall be included in the protection scope of the present application. Therefore, the protection scope of the present application shall be based on the protection scope of the claims.

What is claimed is:

1. A two-dimensional scanning galvanometer device, comprising a first magnet, a second magnet, a magnetic yoke, a galvanometer chip, a base, a cover plate, and a flexible circuit board, wherein:
the first magnet is a ring-shaped permanent magnet and is disposed above the magnetic yoke;
the second magnet is a permanent magnet and is disposed above the magnetic yoke;
the magnetic yoke is configured to support the first magnet and the second magnet;
the galvanometer chip is disposed above the first magnet;
the first magnet, the second magnet, the magnetic yoke and the galvanometer chip are all located inside the base;
the cover plate is connected to the base and is disposed above the base; and
the flexible circuit board is connected to the galvanometer chip.

2. The two-dimensional scanning galvanometer device according to claim 1, wherein:
an outer contour and an inner contour of the first magnet are both rounded rectangles, and the surface thereof is configured to position and support the galvanometer chip.

3. The two-dimensional scanning galvanometer device according to claim 2, wherein:
the second magnet is disposed in the rounded rectangular through hole of the first magnet.

4. The two-dimensional scanning galvanometer device according to claim 3, wherein:
a material of the magnetic yoke is a high permeability material, and the magnetic yoke is bonded to the first magnet and the second magnet respectively through an adhesive in a groove.

5. The two-dimensional scanning galvanometer device according to claim 4, wherein:
the base is a housing, and a cavity inside the housing is configured to support the magnetic yoke and the first magnet,
wherein the first magnet, the second magnet, the magnetic yoke, and the galvanometer chip are all located in the cavity of the base.

6. The two-dimensional scanning galvanometer device according to claim 2, wherein:
the galvanometer chip comprises a movable coil frame, a base, a reflector, a first torsion axis, and a second torsion axis,
wherein an outer contour of the movable coil frame is connected to the base through the second torsion axis, and the inner contour of the movable coil frame is connected to the reflector through the first torsion axis; and
wherein, in a vertical direction, the first torsion axis is located on both sides of the reflector; and in a horizontal direction, the second torsion axis is located on both sides of the movable coil frame.

7. The two-dimensional scanning galvanometer device according to claim 6, wherein:
the movable coil frame has multiple turns of metal conductive coils, and the multiple turns of metal conductive coils are disposed above the rounded rectangular through hole area of the first magnet.

8. The two-dimensional scanning galvanometer device according to claim 7, wherein:
the cover plate is disposed above the galvanometer chip and is connected and fixed to the base; and
the cover plate also includes a viewing window, and the side wall of the viewing window is inclined.

9. The two-dimensional scanning galvanometer device according to claim 8, wherein:
one end of the flexible circuit board is connected to the galvanometer chip, and the other end is connected to a power source for energizing the conductive coil on the movable coil frame.

10. The two-dimensional scanning galvanometer device according to claim 9, wherein:
the first magnet and the second magnet are magnetized in a multi-pole manner; and
a magnetization direction of the first magnet and the second magnet is the thickness direction of the permanent magnet, and a magnetic domain direction of the permanent magnet is parallel to the magnetization direction.
